(19) United States
(12) Patent Application Publication
(10) Pub. No.: US 2017/0366965 A1
(43) Pub. Date: Dec. 21, 2017

(54) COMMUNICATION DEVICE, COMMUNICATION SYSTEM AND METHOD THEREFOR

(71) Applicant: Chiun Mai Communication Systems, Inc., New Taipei (TW)

(72) Inventor: YU-CHEN CHEN, New Taipei (TW)

(21) Appl. No.: 15/187,807

(22) Filed: Jun. 21, 2016

(51) Int. Cl. H04W 8/22; H04W 4/22; H04M 1/725

(52) U.S. Cl. CPC H04W 8/22; H04M 1/72577; H04W 4/22

(57) ABSTRACT

A communication system includes at least one first device having a first display and at least one base station configured to send a mission command to the first device. The first device is configured to receive the mission command and change a setting of the first display from a first value to a second value in response to the mission command.

### FIELD

The disclosure generally relates to communication systems, and particularly to a device-to-device (D2D) communication device, system and method used in public security.

### BACKGROUND

Communication devices today can communicate data and multimedia files or streams beyond simple audio communications. A display has become one of the most important components of the communication devices to display data and multimedia streams or files. People working in public safety organizations such as police stations and fire departments, when working in a dark or dim environment, may require a display which can reduce dark adaptation effect, where the dark adaptation refers to an adaptability degree of the eyes for the change of surrounding luminance from light to dark conditions as time goes by and may negatively affect execution of the mission and even risk harm in a dark environment.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a system architecture of one embodiment of a device-to-device (D2D) communication system.

FIG. 2 is a block diagram of one embodiment of a communication device of the D2D communication system of FIG. 1.

FIG. 3 is a system architecture of another embodiment of the communication system of FIG. 1.

FIG. 4 is a protocol diagram for illustrating a communication method for the communication system of FIG. 3, according to a first exemplary embodiment.

FIG. 5 is a schematic view of connections between a first device and a plurality of second devices.

FIG. 6 is a protocol diagram for illustrating a communication method for the communication system of FIG. 3, according to a second exemplary embodiment.

FIG. 7 is a protocol diagram for illustrating a communication method for the communication system of FIG. 3, according to a third exemplary embodiment.

FIG. 8 is a protocol diagram for illustrating a communication method for the communication system of FIG. 3, according to a fourth exemplary embodiment.

FIG. 9 is a block diagram of another embodiment of the communication device of the D2D communication system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

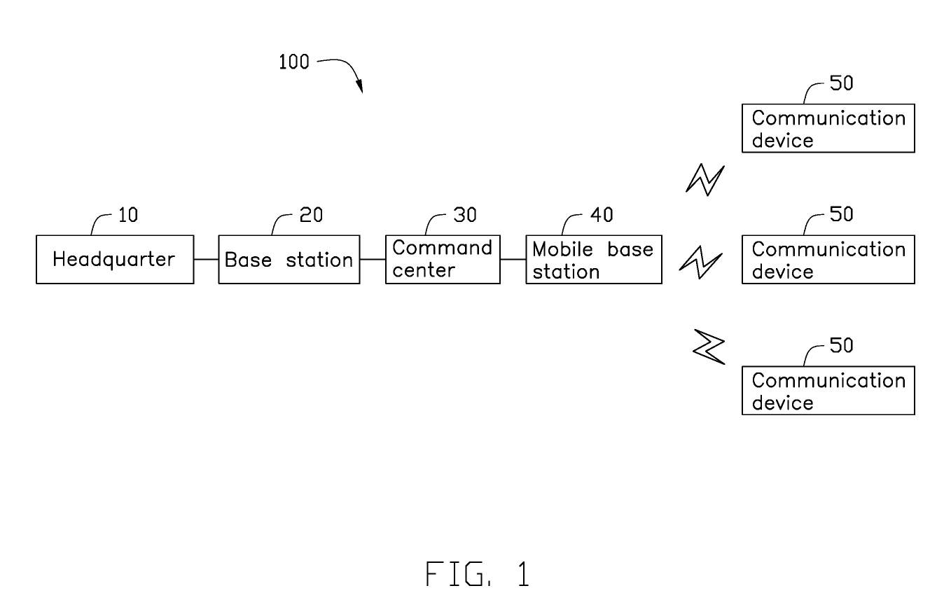

FIG. 1 shows a system architecture of one embodiment of a D2D communication system 100. The communication system 100 includes a headquarter 10, a base station 20, a command center 30, at least one mobile base station 40 (one is shown in FIG. 1), and a plurality of communication devices 50. The mobile base station 40 is configured to wirelessly serve the communication devices 50. In one embodiment, the system architecture can be implemented in public safety organizations, such as police stations, fire departments, emergency management agencies, rescue squads, or the like. In one embodiment, the communication system 100 can be implemented by a communication system, e.g. LTE system, defined by the 3rd Generation Partnership Project (3GPP) standards organization.

When the headquarter 10 receives a mission, the headquarter 10 sends a mission command to the command center 30 via the base station 20. The command center 30 receives the mission command from the headquarter 10 and sends the mission command to the communication devices 50 via the mobile base stations 40. The mission command is configured to switch the communication devices 50 from a normal mode to a mission mode. The mission command can include at least one of a mission region and a mission time.

In other embodiment, the headquarter 10 can directly send the mission command to a server (not shown), replacing the command center 30, and the server then sends the mission command to the communication devices 50 via the mobile base stations 40.

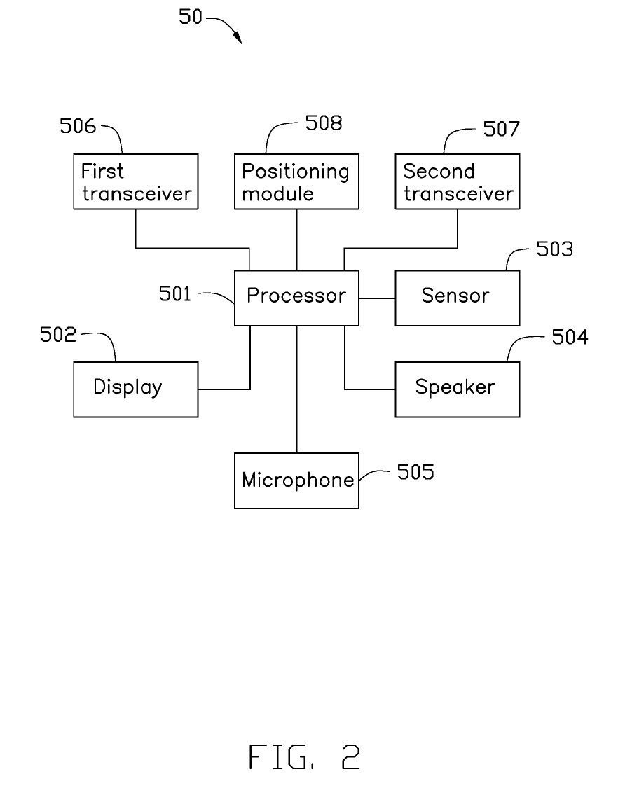

FIG. 2 illustrates that, in an exemplary embodiment, the communication device 50 includes a processor 501, a display 502, a sensor 503, a speaker 504, a microphone 505, a first transceiver 506, a second transceiver 507, and a positioning module 508. The display 502, the sensor 503, the speaker 504, the microphone 505, the first transceiver 506, the second transceiver 507, and the positioning module 508 are electronically connected to the processor 501.

The processor 501 is configured to switch the communication device 50 between the normal mode and the mission mode. The display 502 is configured to display information. The sensor 503 is configured to sense brightness of the surroundings of the communication device 50. The speaker 504 and the microphone 505 are configured to output and input audio signals. In this exemplary embodiment, the first transceiver 506 may be a BLUETOOTH (BT) transceiver or a WiFi transceiver configured to transmit and receive wireless signals using BT or WiFi protocol. The second transceiver 507 may be a second generation (2G) transceiver, a third generation (3G) transceiver, or a fourth generation (4G) transceiver configured to transmit and receive wireless signals using 2G (e.g. CDMA/GSM), 3G (e.g. CDMA2000/WCDMA/TD-SCDMA) or 4G (e.g. LTE) protocol. The positioning module 508 may be a GPS module configured to obtain a current position of the wireless communication device 50.

The communication device 50 can operate in and switch between a normal mode and a mission mode. In this embodiment, the communication device 50 can switch from the normal mode to the mission mode when the second transceiver 507 receives a mission command from the base station 20. In the mission mode, at least one portion of the display 502 of the wireless communication device 50 emits visible light in the 500 nm to 700 nm spectrum which may include monochromatic light such as red light and orange light. In addition, the speaker 504 of the communication device 50 is controlled by the processor 501 to be muted in the mission mode so that the second transceiver 507 of the communication device 50 can receive an incoming call and a message without audible warning generated by the speaker 504 during the mission mode. In other embodiment, in the mission mode, the processor 501 can further control a vibrator (not shown) to generate a vibration warning without audible warning when the second transceiver 507 of the communication device 50 receives an incoming call and a message.

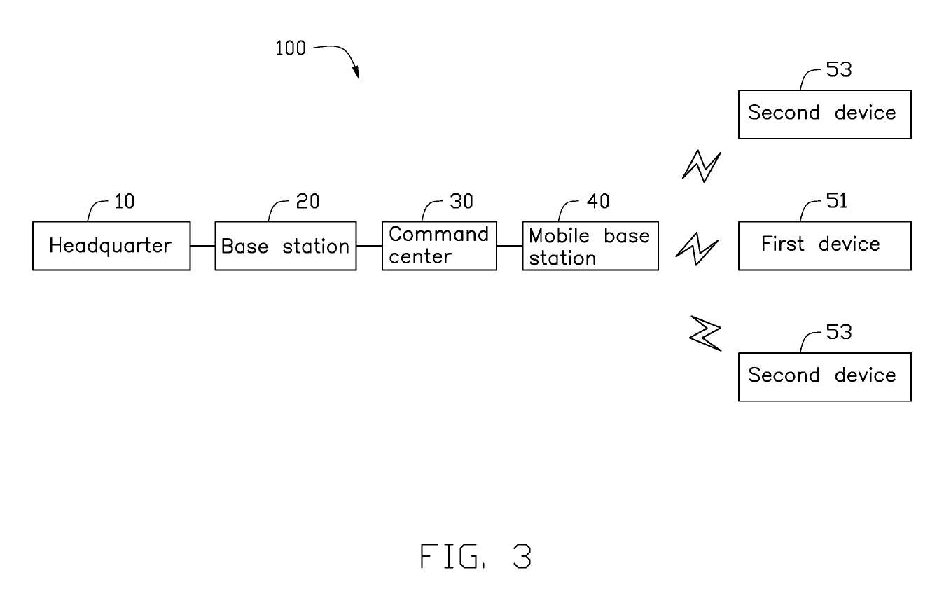

FIG. 3 illustrates that, in one embodiment, the communication devices 50 includes at least one first device 51 and at least one second devices 53. For simplicity of illustration, one first device 51 and two second devices 53 are shown in FIG. 3. In addition, the first device 51 and the second device 53 can be implemented by the communication device 50 as shown in FIG. 2.

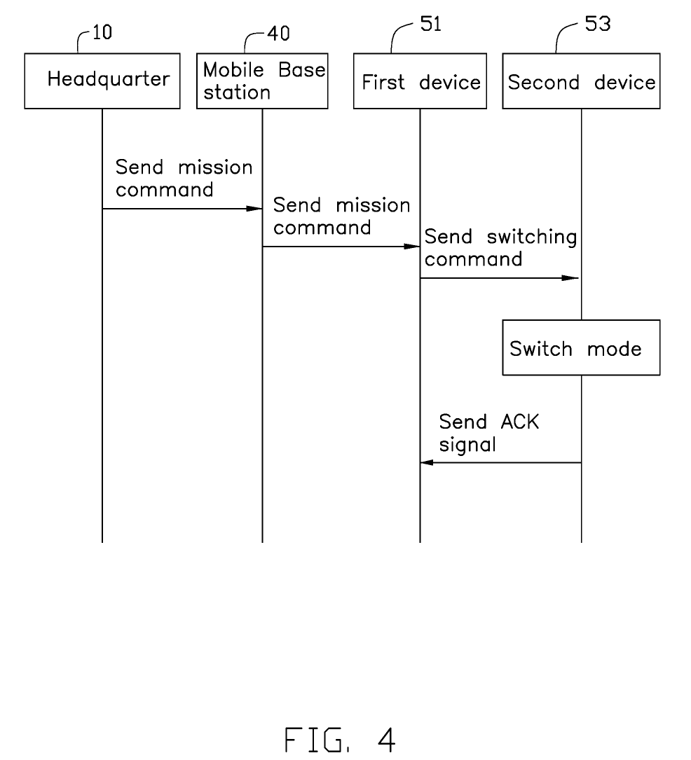

FIG. 4 is a protocol diagram for illustrating a communication method for the communication system of FIG. 3, according to a first exemplary embodiment. The headquarter 10 sends the mission command to the first device 51 via the base station 20, the command center 30 and the mobile base station 40. In other embodiment, the headquarter 10 can send the mission command to the first device 51 directly via the base station 20 or the mobile base station 40 without the command center 30. Alternatively, the command center 30 can receive a mission and send a corresponding mission command to the first device 51 via the mobile station 40 directly without any headquarter 10. In one embodiment, the mobile base station 40 may be a movable base station mounted in a vehicle, e.g., a police car. In another embodiment, the mobile base station 40 may be replaced by a base station fixed in a specific location. The second transceiver 507 of the first device 51 receives the mission command from the mobile base station 40, and the first device 51 then switches from the normal mode into the mission mode in response to the mission command. In one embodiment, the first device 51 can switch from the normal mode into the mission mode by changing a setting of the display 502 from a first value to a second value in response to the mission command. In this embodiment, the processor 501 is configured to change the setting of the display and switch the first device 51 from the normal mode into the mission mode or switch from the mission mode to the normal mode. The setting can be a value representing a wavelength of light emitted by the display 502; and the first value (e.g., 400 nm) can be outside of a range between 500 nm and 700 nm and the second value (e.g. 600 nm) can be within the range between 500 nm and 700 nm. In another embodiment, the setting can be a value representing a color of light emitted by the display 502; and the first value can represent, for example, blue light and the second value can represent, for example, orange or red light. After receiving the mission command and/or switching from the normal mode into the mission mode, the first device 51 then sends a corresponding switching command to the second devices 53. The second transceiver 507 of the second device 53 receives the switching command from the first device 51, and the second device 53 then switches from the normal mode into the mission mode in response to the switching command. Similarly, the second device 53 can switch from the normal mode into the mission mode by changing a setting of its display 502 from a third value, representing a wavelength (e.g. 400 nm) or a color of light (e.g. blue light), to a forth value, representing another wavelength (e.g. 600 nm) or another color of light (e.g. orange light), in response to the switching command. After switching into the mission mode, the second device 53 sends an acknowledgement (ACK) signal to the first device 51 in response to the switching command. In this embodiment, the switching command can be sent by the first transceiver 506 or the second transceiver 507 of the first device 51 and received by the first transceiver 506 or the second transceiver 507 of the second device 53. In addition, the ACK signal can be sent by the first transceiver 506 or the second transceiver 507 of the second device 53 and received by the first transceiver 506 or the second transceiver 507 of the first device 51.

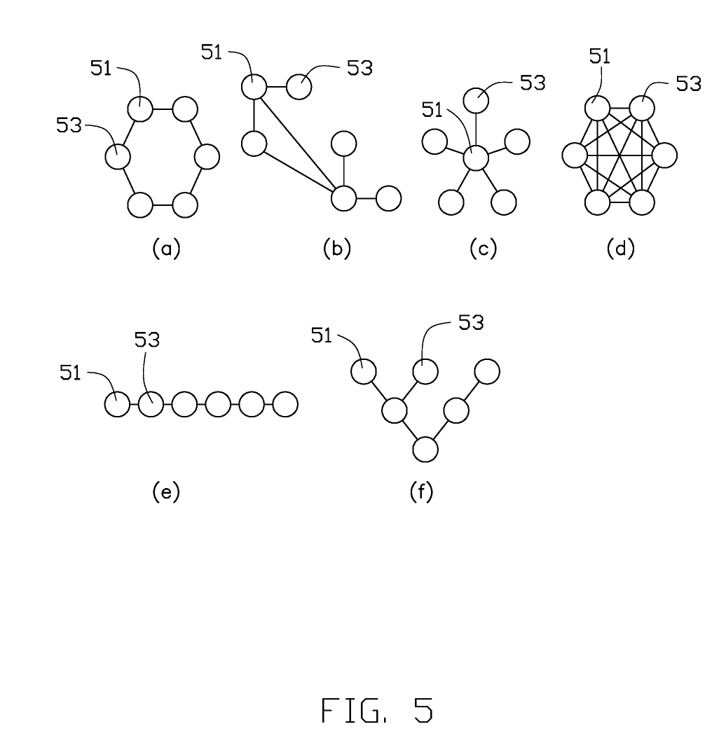

The first device 51 and the second device 53 can communicate with each other by a device-to-device (D2D) wireless communication protocol. In one embodiment, the D2D wireless communication protocol can be ProSe (Proximity based Services) protocol defined by the 3GPP standards organization. The D2D wireless communication protocol can include, but is not limited to, a search mechanism, a listening mechanism, a negotiation mechanism, a security setting mechanism, an address setting mechanism, a particular message communication mechanism, etc. FIG. 5 illustrates that, a topographical representation as to connections between the first device 51 and the second devices 53 can be, but is not limited to, ring-shaped, mesh-shaped, star-shaped, line-shaped, and tree-shaped.

In other embodiment, the first device 51 can also send any type of data or control commands to the second devices 53. The control commands can be, but are not limited to, a volume adjusting command for adjusting a sound volume of the speaker 504 of the second devices 53 or a mode controlling command for switching the second devices 53 from the normal mode to other mode, such as a power saving mode.

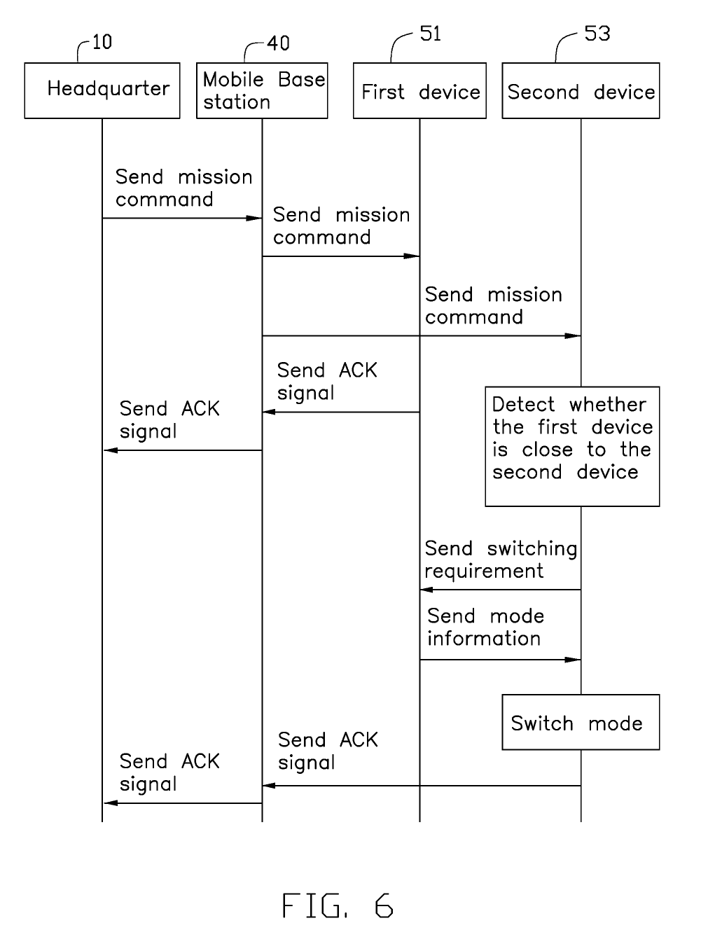

FIG. 6 is a protocol diagram for illustrating a communication method for the communication system of FIG. 3, according to a second exemplary embodiment. The headquarter 10 sends the mission command to the mobile base station 40. The mobile base station 40 sends the mission command to the first device 51 and the second devices 53, respectively. The second transceiver 507 of the first device 51 receives the mission command from the mobile base station 40, and the first device 51 then switches from the normal mode into the mission mode. After switching into the mission mode, the first device 51 sends an ACK signal to the mobile base station 40 in response to the mission command. The mobile base station 40 then sends the ACK signal to the headquarter 10 so as to notify the headquarter that the first device 51 has received the mission command.

The second transceiver 507 of the second device 53 receives the mission command from the mobile base station 40, and the second device 53 then detects, in response to the mission command, whether the first device 51 is close to the second device 53. If the second device 53 detects that the first device 51 is close to the second device 53, the second device 53 switches from the normal mode to the mission mode by changing a setting of its display 502. In one embodiment, if the second device 53 detects that the first device 51 is close to the second device 53, the second device 53 sends a switching requirement to the first device 51. The first device 51 receives the switching requirement from the second device 53 and sends mode information to the second device 53 in response to the switching requirement. The mode information can include a setting, e.g., a wavelength or a color of light, of the display 502 or a setting of the speaker 504 of the first device 51 operating in the mission mode. The second device 53 receives the mode information, e.g., the setting of the display 502 or the setting of the speaker 504, from the first device 51 and switches from the normal mode to the mission mode by changing the setting of its display 502 or the setting of its speaker 504 according to the mode information. After switching into the mission mode, the second devices 53 also sends the ACK signal to the mobile base station 40. The mobile base station 40 then sends the ACK signal to the headquarter 10 so as to notify the headquarter 10 that the second device 53 has received the mission command. In one embodiment, the second device 53 detects whether the first device 51 is close to it according to a measured strength of a signal received from the first device 51. For example, the second device 53 can detect that the first device 51 is close to it when it determines that the measured strength of the signal received from the first device 51 is greater than a threshold. In this embodiment, the mode information can be sent by the first transceiver 506 or the second transceiver 507 of the first device 51 and received by the first transceiver 506 or the second transceiver 507 of the second device 53. In addition, the switching requirement can be sent by the first transceiver 506 or the second transceiver 507 of the second device 53 and received by the first transceiver 506 or the second transceiver 507 of the first device 51.

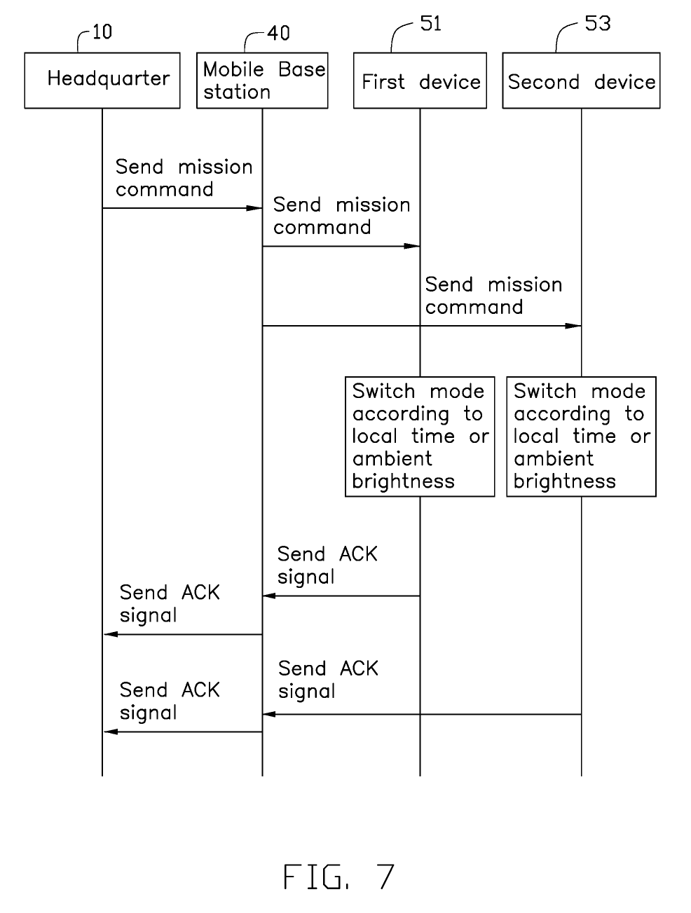

FIG. 7 is a protocol diagram for illustrating a communication method for the communication system of FIG. 3, according to a third exemplary embodiment. The headquarter 10 sends the mission command to the mobile base station 40. The mobile base station 40 sends the mission command to the first device 51 and the second devices 53, respectively. After receiving the mission command, the first device 51 and the second devices 53 automatically switch from the normal mode into the mission mode according to a local time and/or ambient brightness sensed by the sensor 503. For example, if the local time is at evening, night or midnight or if the ambient brightness is less than a predetermined value, the first device 51 and the second devices 53 can automatically switch from the normal mode into the mission mode. After switching into the mission mode, the first device 51 and the second devices 53 send the ACK signals to the mobile base station 40. The mobile base station 40 then sends the ACK signals to the headquarter 10 so as to notify the headquarter 10 that the first device 51 and the second device 53 have received the mission command. In this embodiment, the first device 51 and the second device 53 can switch from the normal mode into the mission mode by changing the settings of their displays 502 in the same manner described above, and the ACK signals can be sent by the second transceiver 507 of the first and second devices 51, 53 to the mobile base station 40.

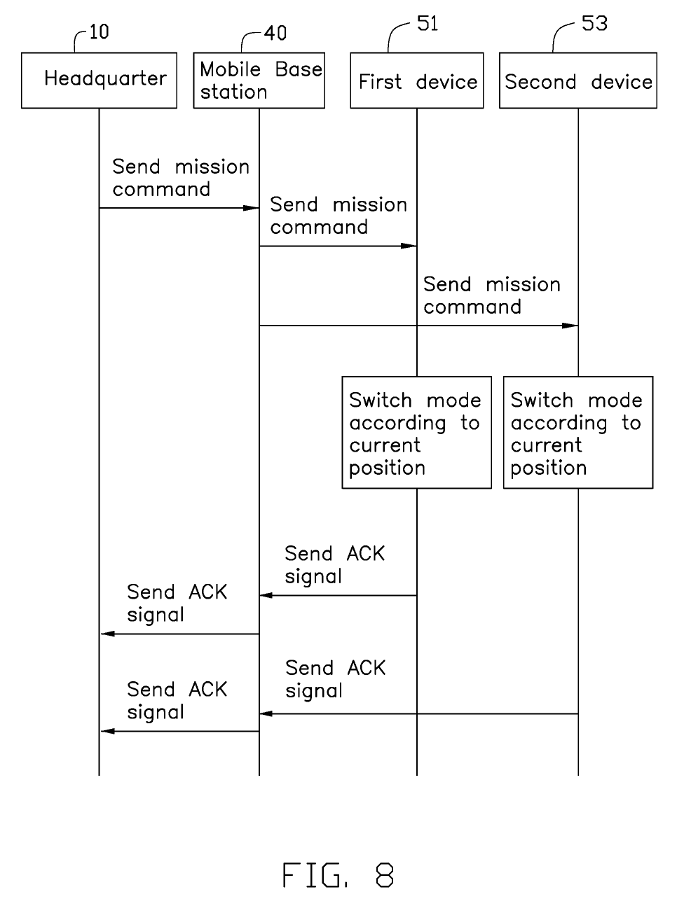

FIG. 8 is a protocol diagram for illustrating a communication method for the communication system of FIG. 3 according to a fourth exemplary embodiment. The headquarter 10 sends the mission command to the mobile base station 40. The mobile base station 40 sends the mission command to the first device 51 and the second devices 53, respectively. After receiving the mission command, the first device 51 and the second device 53 switch from the normal mode into the mission mode according to a current position. For example, if the current position obtained by the positioning module 508 is within the mission region, the first device 51 and the second devices 53 automatically switch from the normal mode into the mission mode. After switching into the mission mode, the first device 51 and the second devices 53 send the ACK signals to the mobile base station 40. The mobile base station 40 then sends the ACK signals to the headquarter 10 so as to notify the headquarter 10 that the first device 51 and the second device 53 have received the mission command. In this embodiment, the first device 51 and the second device 53 can switch from the normal mode into the mission mode by changing the settings of their displays 502 in the same manner described above, and the ACK signals can be sent by the second transceiver 507 of the first and second devices 51, 53 to the mobile base station 40.

After the mission is finished, the first device 51 can switch back from the mission mode into the normal mode by changing the setting of its display 502 from the second value (e.g. 600 nm) to the first value (e.g. 400 nm) and send a recovery command to the second devices 53. The second devices 53 receive the recovery command from the first device 51 and also switch back from the mission mode into the normal mode by changing the setting of its display 502 from the forth value (e.g. 600 nm) to the third value (e.g. 400 nm) in response to the recovery command.

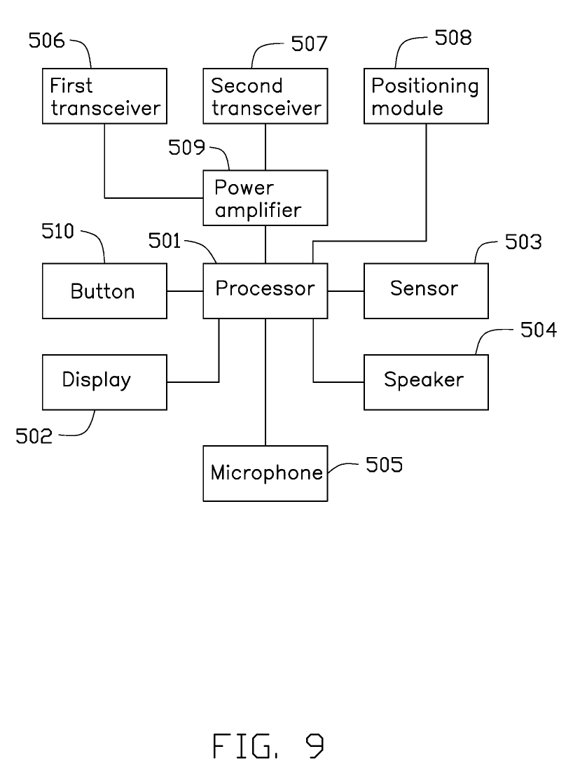

FIG. 9 illustrates another embodiment of the communication device of FIG. 1. The first device 51 and the second device 53 shown in FIG. 3 can also be implemented by the communication device of FIG. 9. The communication device further includes a power amplifier 509 electronically connected between the processor 501 and the first and second transceivers 506, 507. A transmission power of the amplifier 509 of the first device 51 is increased before the first device 51 sends the commands and information (e.g. the switching command, the mode information, the controlling commands, and the recovering command) to the second devices 53, to ensure that the second devices 53 can receive the commands.

In addition, the communication device further includes a button 510 electronically connected to the processor 501 and positioned outside a housing (not shown) of the communication device. The button 510 can manually switch the communication device 50 from a normal mode to a mission mode.

The D2D communication system in the present application as described in the above embodiments can be applied to a plurality of public safety organizations. For example, in a police station, the first device 51 can be used by a supervisor at the police station and the second devices 53 can be used by others. When the headquarter 10 receives a mission, the headquarter 10 sends the mission command to the first device 51 via the mobile base station 40. The first device 51 receives the mission command from the mobile base station 40 and switches from the normal mode into the mission mode. The first device 51 sends the corresponding switching command to the second devices 53. The second device 53 receives the switching command from the first device 51 and also switches from the normal mode into the mission mode in response to the switching command. After the mission is finished, the first device 51 switches back from the mission mode into the normal mode and sends the recovery command to the second devices 53. The second devices 53 receive the recovery command from the first device 51 and also switch back from the mission mode into the normal mode in response to the recovery command.

When the headquarter 10 accepts a mission, the headquarter 10 sends a mission command to the communication devices 50 to switch the communication device 50 from the normal mode to the mission mode in which at least one portion of the display 502 of the communication device 50 emits monochromatic light such as red light and orange light. Therefore, the display 502 can reduce eye adaptation effect and thus avoid risk harm during execution of a mission.

It is to be understood, however, that even through numerous characteristics and advantages of the present disclosure have been set fourth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

1. A communication system comprising:
at least one first device having a first display; and
at least one base station configured to send a mission command to the first device;
at least one second device having a second display;
wherein the first device is configured to receive the mission command and change a setting of the first display from a first value to a second value in response to the mission command;
wherein the first device is further configured to change the setting of the first display according to a position of the first device combining with a local time;
wherein the base station is further configured to send the mission command to the second device, if the second device detects that the first device is close to the second device, the second device sends a switching requirement to the first device; the first device receives the switching requirement and sends mode information to the second device; and the second device receives the mode information and changes the setting of the second display from a third value to a fourth value according to the mode information.

2. The communication system of claim 1, wherein the first device further has a speaker and the first device is further configured to change a setting of the speaker in response to the mission command.

3. The communication system of claim 1, wherein the setting is a wavelength of light emitted by the first display, and the wavelength is between 500 nm and 700 nm.

4. The communication system of claim 1, wherein the first device is further configured to send a switching command to the second device after receiving the mission command, and the second device is configured to receive the switching command and change a setting of the second display from the third value to the fourth value in response to the switching command.

5. The communication system of claim 4, wherein the first device is further configured to send a recovery command to the second device, and the second device is configured to receive the recovery command and change the setting of the second display from the fourth value to the third value in response to the recovery command.

6. (canceled)

7. The communication system of claim 1, wherein the first device is further configured to send a recovery command to the second device, and the second device is configured to receive the recovery command and change the setting of the second display from the fourth value to the third value in response to the recovery command.

8. (canceled)

9. The communication system of claim 1, wherein the second device detects that the first device is close to the second device according to the strength of a signal received from the first device.

10. (canceled)

11. A communication method for a communication system, the communication system comprising at least one first device having a first display and at least one second device having a second display, and at least one base station, the method comprising:
sending a mission command from the base station to the first device and the second device;
changing a setting of the first display from a first value to a second value in response to the mission command after the first device receives the mission command; and
further changing the setting of the first display according to a position of the first device combining with a local time;
sending a switching requirement from the second device to the first device if the second device detects that the first device is close to the second device;
sending mode information from the first device to the second device after the first device receives the switching requirement; and
changing a setting of the second display from a third value to a fourth value according to the mode information after the second device receives the mode information.

12. The communication method of claim 11, wherein the first device further has a speaker, the method further comprising:
changing a setting of the speaker in response to the mission command.

13. The communication method of claim 11, wherein the setting is a wavelength of light emitted by the first display, and the wavelength is between 500 nm and 700 nm.

14. The communication method of claim 11, further comprising:
sending a switching command from the first device to the second device after the first device receives the mission command; and
changing a setting of the second display from the third value to the fourth value in response to the switching command after the second device receives the switching command.

15. The communication method of claim 14, further comprising:
sending a recovery command from the first device to the second device; and
changing the setting of the second display from the fourth value to the third value in response to the recovery command after the second device receives the recovery command.

16. (canceled)

17. The communication method of claim 11, the method further comprising:
sending a recovery command from the first device to the second device; and
changing the setting of the second display from the fourth value to the third value in response to the recovery command after the second device receives the recovery command.

18. (canceled)

19. A communication device comprising:
a display;
a transceiver configured to receive a mission command sent from a base station;
a processor electrically connected to the display and the transceiver and configured to change a setting of the display from a first value to a second value in response to the mission command and also change the setting of the first display according to a position of the first device combining with a local time;
wherein the base station is further configured to send the mission command to a second communication device, if the second communication device detects that the communication device is close to the second communication device, the second communication device sends a switching requirement to the communication device; the communication device receives the switching requirement and sends mode information to the second communication device; and the second communication device receives the mode information and changes the setting of a second display from a third value to a fourth value according to the mode information.

20. The communication device of claim 19, wherein the setting represents a wavelength or a color of light emitted by the display.
